(19) United States
(12) Patent Application Publication
(10) Pub. No.: US 2021/0391094 A1
(43) Pub. Date: Dec. 16, 2021

(54) Utilizing Multiple Proton Injection Ports in Accelerator Driven Subcritical Reactor for Direct Adopting Spent Fuels from Light Water Reactors

(71) Applicant: Jiatsong Jason Chao, Cupertino, CA (US)

(72) Inventor: Jiatsong Jason Chao, Cupertino, CA (US)

(21) Appl. No.: 16/897,266

(22) Filed: Jun. 10, 2020

(51) Int. Cl. G21G 1/02; G21C 1/30; G21C 3/42

(52) U.S. Cl. CPC G21G 1/02; G21C 3/42; G21C 1/303

(57) ABSTRACT

The new features of an accelerator driven subcritical reactor disclosed by this invention include the multiple intake ports connected to the reactor vessel for delivering protons from one or more accelerators to accommodate the full length LWR spent fuels for furnishing the desirable neutron distribution in a subcritical core to incinerate nuclear wastes. This is based on the notion of adopting the spent fuels in intact form to feed directly to the newly designed subcritical core. External modulators in the proton intake ports have the ability of splitting the fluxes and adjusting their energy from one or more accelerators to form multiple proton streams arriving at different axial locations in the spallation target for creating multiple neutron sources. The new design could combine the cycles of reprocessing spent fuels, manufacturing fuels for reuse, and incinerating minor actinides into one single cycle.

### BACKGROUND OF THE INVENTION

### Technical Field

The present invention relates to transmutation of nuclear waste in accelerator driven subcritical (ADS) reactors.

### Background Art

Three categories of prior art for this invention are identified: 1) the U.S. patents, 2) patent applications, and 3) existing ADS projects reported in the literature. As this invention falls in the category of using an accelerator driven subcritical reactor to eliminate high level nuclear waste of minor actinides, many other look-alike subjects or prior art would not fit in well with this category. These unfitted categories include the fast breeder reactors, molten salt reactors, high temperature gas cooled reactors, fusion reactors, hybrid reactors, reactors for energy multiplication purposes, or light water reactors with transmutation features, none of which are listed as a prior art.

U.S. patent Documents

| | | |
|---|---|---|
| 3,349,001 | October 1967 | Stanton |
| 4,309,249 | January 1982 | Steinberg et al. |
| 5,160,696 | November 1992 | Bowman |
| 5,768,329 | June 1998 | Berwald |
| 5,774,514 | June 1998 | Rubbia |
| 6,233,298 | May 2001 | Bowman |

U.S. patent applications

| | | |
|---|---|---|
| 20040022342 | February 2004 | Magil et al. |
| 20050013397 | January 2005 | Csom et al. |
| 20130051508 | February 2013 | McIntyre et al. |

U.S. Pat. No. 6,233,298, entitled “Apparatus for transmutation of nuclear reactor waste,” to Bowman, issued on May 15, 2001. This patent discloses an accelerator driven reactor to supplement neutrons in a reactor to address nuclear waste by transmutation. The reactor contains molten salts and plutonium and minor actinides.

U.S. Pat. No. 5,774,514, entitled “Energy Amplifier for Nuclear Energy Production Driven by a Particle Beam Accelerator,” to Rubbia, issued Jun. 30, 1998. This patent discloses a method for producing energy with an external accelerator delivering protons or deuterons in the reactor to produce neutrons by spallation with the target in the reactor. The neutrons generated by this process will interact with the fissile material such as Thorium 233 as the breeding medium for producing the fissionable materials such as Uranium 233 and Uranium 235 to achieve the energy multiplication effect.

U.S. Pat. No. 5,768,329, entitled “Apparatus for Accelerator Production of Tritium,” to Berwald, issued Jun. 16, 1998. This patent discloses a design of using an external accelerator to deliver protons in a reactor by spallation with the target of molten lithium alloy for the purpose of producing tritium.

U.S. Pat. No. 5,160,696, entitled “Apparatus for Nuclear Transmutation and Power Production using an Intense Accelerator-generated Thermal Neutron Flux,” to Bowman, issued Nov. 3, 1992. This patent discloses an accelerator to deliver high energy protons to bombard with a spallation target such as a liquid lead-bismuth eutectic mixture for the purpose of incinerating nuclear waste.

U.S. Pat. No. 4,309,249, entitled “Neutron Source, Linear-Accelerator Fuel Enricher and Regenerator and Associated Methods,” to Steinberg et al., issued Jan. 5, 1982. This patent discloses a design of using an accelerator to deliver high energy protons to bombard with a spallation target such as a liquid lead-bismuth eutectic mixture for the purpose of producing plutonium.

U.S. Pat. No. 3,349,001, entitled “Molten Metal Proton Target Assembly,” to Stanton, issued Oct. 24, 1967. This patent discloses a design of using an accelerator to deliver high energy protons to bombard with a spallation target such as a liquid lead-bismuth eutectic mixture or molten lead in the core for the purpose of producing the required neutrons. The produced neutrons will interact with Lithium6 in the core for fusion reactions. Using uranium 238 or thorium 232 would enhance the neutron production for the desired fusion reactions.

Patent Applications

United States Patent Application No. 20130051508, dated Feb. 28, 2013, entitled “Accelerator Driven SubCritical Core,” filed by McIntyre et al. This patent application discloses a design of external accelerators to furnish protons into a reactor core similar to a molten salt reactor with thorium 233 or plutonium 238 as the breeding medium for generation neutrons. This design includes a molten salt purification system using lanthanides online.

United States Patent Application No. 20050013397, dated Jan. 20, 2005, entitled “Method of and apparatus for transmuting radioactive waste,” filed by Csom et al. This patent application discloses a design of an accelerator external to the core for delivering protons to a molten salt reactor of which the core is divided in several regions. Each region adopts different molten salts of variant waste contents to take advantage of the spatial neutronic characteristics.

United States Patent Application No. 20040022342, dated Feb. 5, 2004, entitled “Method of incineration of minor actinides in nuclear reactors,” filed by Magill et al. This patent application does not involve with the use of an accelerator but to design for the arrangement in existing nuclear reactors to better incinerate the minor actinides.

Existing ADS Projects

About 20 years ago, nuclear industries in many countries began to pay attention to the design, experiments, and prototyping efforts on the Accelerator Driven Subcritical (ADS) reactors for incinerating nuclear wastes. This was because the other options for handling the nuclear wastes by either the repository approach or the recycling option had faced major obstacles. Utilizing an ADS for incinerating the high-level nuclear waste of mainly minor actinides has gained the momentum in the research activities and realistic implementation endeavors. The countries that have started the efforts on the use of an ADS to eliminate nuclear wastes include Russia, Japan, Korea, India, Belgium, Switzerland, France, China, and U.S.

Among all the efforts by these countries, three major and representative projects are identified that are considered realistic, achievable, and having a completion schedule. These are the Chinese HEIT (Highly Efficient Industrial Transmuter) ADS, the European MYRRHA (Multi-purpose hybrid Research Reactor for High-tech Applications, in Belgium), and the Japan Atomic Energy Agency (JAEA) Reference ADS design. These three projects are illustrated as the prior art as a baseline design for comparing with this invention so that the novelty of this invention could be brought out clearly without any ambiguity.

China

The Chinese HEIT is a system that consists of a proton accelerator, a spallation target and a subcritical core as the ADS (1,2,3,4,5,6). The HEIT is a part of the Chinese national program called DANES (accelerator-driven advanced nuclear energy system) that consists of the waste burner system of HEIT and a fuel recycle system. The nominal reactor power for the waste burning ADS is 800 MW thermal. An accelerator delivers protons at the energy of 1.5 GeV into the center of the HEIT ADS core through a vertical port form the top of the HEIT. The high energy protons interact with the target material in the center of the core by nuclear reactions for producing fast neutrons. The fast neutrons get dispersed into the bulk of the core and cause nuclear reactions with the fuels that eliminate the high-level wastes of minor actinides in the fuels.

The ADS active core has the dimensions of 110 cm as the height and 363.4 cm as the diameter, with fuel elements made of plutonium isotopes and minor actinides. The molten salt lead-bismuth eutectic (LBE) is used as the coolant as well as the spallation target.

European MYRRHA

The MYRRHA project (7,8,9,10) in Belgium funded by the Belgians and endorsed by the European Strategy Forum on Research Infrastructures will be built by 2033 for the purpose of eliminating nuclear wastes via transmutation as a demonstration facility. MYRRHA is designed for the research and development of many related applications and consists of an accelerator delivering protons to a spallation target in a subcritical core (ADS). The accelerator will deliver protons at a flow of 4 mA and of energy at 600 MeV. The ADS is designed to be operational at power level of 100 MW thermal.

The MYRRHA ADS active core has the dimensions of 200 cm as the height, with fuel elements made of plutonium and uranium. The molten salt LBE is used as the coolant as well as the spallation target.

Japan

The Japan Atomic Energy Agency (JAEA) has planned to build a LBE cooled ADS to transmute minor actinides (11,12,13,14,15,16). This effort consists of a high intensity proton accelerator with 1.5 GeV beam energy, a spallation target of LBE and a subcritical core at 800 MW thermal power. The spallation target is placed at the center of the subcritical core and the proton beam is injected into the target from top of the ADS. The subcritical core is driven by or sustained the neutrons generated from the target via spallation by protons. The subcritical core was designed to have the capacity of transmuting about 250 kg minor actinides per year.

This ADS active core has the dimensions of 100 cm as the height and 244 cm as the diameter, with fuel elements made of plutonium isotopes and minor actinides. The LBE is used as the coolant as well as the spallation target.

Research and Development Efforts by Other Countries

There are other countries that have engaged the research and development efforts to some extent on the use of an ADS for the purpose of eliminating nuclear wastes by transmutation. As these countries each has a different energy plan, individual country has adopted different partitioning and transmutation strategies. Their research and development efforts on ADS addressed different technical aspects related to ADS without designing or prototyping for a full scope of ADS.

The ADS related research efforts in Russia have been focused on the research work related to spallation target materials, the coolants, and the durable structural constituents for future ADS applications (17). The current research projects at Troitsk as an experimental complex include several scientific research tasks with diversified objectives, one of which may eventually evolve into an ADS arrangement.

India has focused on the use of thorium for their future reactor design because of the thorium abundance in India (18). They have adopted the nuclear energy strategy based on the thorium cycle for its breeding features. Therefore, the research and development efforts on the accelerator technology has a focus on the breeding of U233 from Th233 which is different from the theme of eliminating nuclear wastes.

The HISPA [India ADS 1] project administered by the Bhabha Atomic Research Centre in India, concentrates on the development of a high-power proton accelerator of the LINAC type, with a goal for the first stage, to deliver protons at a flow of 30 mA, and of energy of 20 MeV. The ultimate goal is to reach 30 MW for the beam power with 1 GeV protons. The near term LEHIPA (Low Energy High Intensity Proton Accelerator) project in India will be used for critical reactors but not used in conjunction with a subcritical reactor.

Common Features of Prior Art

The ADS is considered a viable and effective approach for incinerating high-level waste. All the ADS designs have shown their basic characteristics of including an external accelerator to deliver high energy protons, a spallation target, and a subcritical reactor core. The accelerators considered include the linear accelerator and the cyclotron approaches. The spallation targets materials considered include lead, tungsten, titanium, neptunium, uranium, americium, and the molten salt LBE. The coolants considered include lead, sodium, and the molten salt LBE. The fuels for the ADS core considered include the separately and specifically manufactured rods of a mixture of plutonium isotopes and minor actinide isotopes.

All the patents, patent applications, and existing ADS designs share with two common features: 1) the fuels for the ADS core have to be manufactured by extracting plutonium from spent fuels first and then repacking plutonium isotopes and minor actinides at various ratios in the new fuels, and 2) only one port is adopted and is connected to the reactor vessel by way either from top or bottom of the vessel.

The accelerator would deliver protons through a long horizontal pipe, with a bent in the pipe placed on the top (or bottom) of the vessel to divert protons flowing from horizontal direction to downward (or upward) into the center of the core inside the reactor vessel. All the existing designs utilize only one intake port to enter the vessel for the entering protons to bombard with the target in the center of the subcritical core. The proton intake port may enter the vessel via the bottom of the vessel as well.

The Japanese design by JAEA has a design of two accelerator tubes to deliver protons towards the reactor but the two accelerator tubes are merged into a single tube before it enters the reactor vessel for considerations of reducing thermal stresses around the target.

Novelty of this Invention

The unique feature of this invention is to use multiple proton intake ports to accommodate the full length of the spent fuels from light water reactors. Based on the notion of no extracting process involved to get plutonium off spent fuels and no packing of plutonium isotopes and minor actinides in the new fuels but adopting the spent fuels directly from LWRs in their intact forms, this new design avoid the additional radioactive wastes produced as a byproduct from the extracting and repacking processes. Such additional radioactive byproducts and the costs for extracting and repacking processes have been recognized in recent years as the causes for the of the deceleration of the fuel reprocessing. (23)

This new design includes the multiple spallation locations along the center axis of the core such that there will be multiple neutron sources in the core from target spallation. The strengths of the neutron sources can be controlled externally by the modulation units outside the reactor vessel such that the neutron distribution in the core could be modulated to have the desirable populations and energies by varying the proton flows in each of the intake ports.

As the direct use of the spent fuels from existing LWRs is adopted, the core design could include the provisions of additional new and separate fuel rods with various fissile materials for enhancing the production of fast neutrons as a heterogeneous core. This is feasible as this is a subcritical reactor in which the required neutrons are furnished externally. Without the design requirement for criticality, additional flexibility exists for different viable design options. The use of the external modulation units for controlling the proton flows and therefore for modulating the neutron production distribution in core would have an additional flexibility in the design of a subcritical core.

General Technical Background

So far there has not been a permanent solution to address the nuclear waste issue worldwide, nor has been a sound, practical, and effective method to handle the spent fuels generated from light water reactors after their use for producing nuclear power commercially. The spent fuels from the existing commercial nuclear power reactors containing in them Plutonium isotopes, nuclear wastes, and fission products are generated as a result of nuclear reactions of neutrons with Uranium 235 and Uranium 238 inside the fuel rods. The nuclear wastes to be addressed are mainly the highly radioactive elements of the Minor actinides due to their high levels of radioactivity and long lifetimes.

Recycle or Underground Storage for Spent Fuels

There have been two strategies so far recognized for handling spent fuels and nuclear wastes worldwide. The first strategy is to leave the spent fuels as they are with all the plutonium, leftover uranium, and high-level wastes in them and store them in a deep underground repository (19,20,21,22). The second strategy is to recycle the nuclear spent fuels by extracting Plutonium and the unused Uranium off them to make new fuels (23,24,25,26). Both strategies currently suffer significant drawbacks politically, technically, and economically. Currently there is not any near-term solution in sight for implementation nor any long-term plan to handle the spent fuels, by either strategy.

Underground Repository Issues

As of today, the option of building a repository to store all the spent fuels has not been successful. There are two or three sites worldwide that have begun the preliminary work for storing the high-level nuclear wastes (19,20,21,22). But no site has a date predicted for its opening for operation. Too many political and economic issues remain unresolved that have caused the congestion of the temporary storage space for spent fuels generated in nuclear power plants everywhere in the world. The following lists the characteristics of the fundamental issues.

1. Proliferation Concerns

Because nuclear spent fuels contain plutonium 239 as a product from burning Uranium 238 in the existing nuclear power reactors, storing the spent fuels without recycling them presents a proliferation concern, as plutonium 239 is also the material for weapons (24).

2. Site Uncertainty

Only Sweden, Finland, China and US so far have a clear plan to build a full-scale underground storage facility. They are far from completion nor could be predicted for their opening date for use (19,20,21,22). The Yucca Mountain site in Nevada as a geological repository planned for storing the spent fuels from U.S. reactors is finished only halfway after its initiation some 20 years ago. The work is now stopped because of strong opposition politically and no one could predict when the work would be resumed. [Yucca Mountain] This is an example for the problems encountered for the repository sites worldwide.

3. Economic Issues

It seems uneconomical to allow the financial investment on the development of a repository site without receiving any return. From energy efficiency perspective, it is not economical to leave the plutonium and uranium in spent fuels without their future utilization, although recent studies indicated that it would be better not to reprocess spent fuels due to the high costs of extracting plutonium and uranium off spent fuels and making new fuels. However, this invention would change such perceived scenario as the two intermediate steps in the existing practice for reprocessing are eliminated when the spent fuels are taken directly from nuclear power plants to feed in an ADS with the new features disclosed by this invention.

Shortfalls of Reprocessing Spent Fuels

The recycling strategy is facing major obstacles too. France, China, U. K. and Japan have adopted the strategy of recycling spent fuels. France is the leading country that has implemented this strategy for decades. Yet, problems associated with fuel recycling surfaced in recent years that would make this strategy less attractive. The following is a list of these problems (23).

1. Remnant of High-Level Radioactivity

Recycling and reprocessing spent fuels was once thought as a permanent solution. But so far only UK, France, Russia and U.S. have developed the related and the needed technologies for this purpose. France has performed reprocessing of spent fuels for several countries as a service for more than 30 years. Yet, while the reprocessing technology could effectively extract plutonium off the spent fuels, the remaining residual high-level wastes after reprocessing would have to return to the country that owns the spent fuels. To many countries this approach does not eliminate nuclear wastes as a final resolution but a strategy to delay the time of confronting the real issue. The nuclear wastes generated from the last stage of the entire fuel cycle as the final leftover are left with no resolution.

2. Generation of Additional Wastes During Reprocessing

While the technologies for extracting plutonium was effective and the plutonium has been used as a new fuel, the involved intermediate processes have created additional and costly problems unexpectedly. The main objective of reprocessing was to extract plutonium off the spent fuels and separate plutonium and the unused uranium from the high-level wastes. Yet, the involved processes have created excessive additional radioactive materials. Although most of these new materials are not considered high level wastes but intermediate or low-level wastes, they still require significant and unexpected costs for their handling and cleanup. For this reason, continuing the efforts in recycling spent fuels has not been encouraged. The future planning for continuing the recycling efforts has stopped temporarily in recent years.

3. High Costs for Extracting Plutonium and Manufacturing Fuels

It is a costly endeavor to extract plutonium from the spent fuels as it involves tedious and complex chemical and physical processes to perform the separation of plutonium and uranium from the spent fuels or the wastes. The nuclear wastes in this context mainly consist of minor actinides and fission products. Safety and shielding measures are heavy capital investments for these endeavors that could contribute to the staggering cost. Countries having adopted alternative financial considerations did not choose to follow the reprocessing and recycling strategy to avoid such huge upfront investment.

In addition to the cost incurred by the extracting tasks, there is an additional cost for making the new fuels for reuse in the power producing reactors or for fueling an Accelerator Driven Subcritical reactor treating minor actinides as the ultimate wastes for their transmutation.

Role of Accelerator Driven Subcritical Systems (ADS)

The partitioning and transmutation (P&T) technologies of long-lived radioactive nuclides such as minor actinides (MAs) is a promising technology to reduce the burden of the geological disposal of the high-level radioactive waste (HLW). Several countries have been continuously performing research and development on the P&T technologies (27,28,29,30,31,32,33,34,35). There have been two concepts proposed to address this issue: one is the homogeneous MA recycling concept in fast breeder reactors (FBRs) and the other is the dedicated MA transmutation cycle concept by a double-stratum approach, using an accelerator-driven system (ADS). Yet, the fast breeder reactor concept since its inception 40 years ago has not been implemented successfully by the nuclear industries worldwide thus far. Therefore, it is now left with the ADS approach as the main option for eliminating the ultimate nuclear waste seriously considered by several countries during the last 20 years.

Several countries are designing and building prototypes of commercially scaled ADSs. The transmutation system consists of a) partitioning of MAs from HLW, b) MA fuel fabrication, c) transmutation by ADS, and d) reprocessing of spent fuel discharged from ADS.

Current Practice

Existing Accelerator Driven Subcritical Systems (ADS)

The FBR option is no longer viewed as the main stream option for incinerating the high level waste. The accelerator driven subcritical system has been seriously considered by many countries during the last 20 years to eliminate the ultimate nuclear wasted separated from spent fuels. The working principle is that these nuclear wastes in the form of minor actinides (MAs) have the properties of engaging nuclear reactions with fast neutrons. Such nuclear reactions will convert minor actinides to other nuclides of much less or no radioactivity, and minor actinides will cease to exist.

Subcritical systems do not have the ability to make the chain reactions as the critical reactors do and therefore cannot generate enough neutrons by fission to sustain the nuclear reactions for continuously eliminating minor actinides. To make enough fast neutrons, an ADS would therefore need to rely on the neutrons supplied externally. An external proton accelerator could fulfill this mission by delivering high energy protons into an ADS and produce neutrons inside the ADS. The delivered protons will bombard a designated target in the ADS core to produce the needed fast neutrons by spallation reactions of the target with protons. China, Belgium, and Japan have announced their plans for building their own versions of a full-scale prototype ADS plant in the next five to ten years.

Shortfalls of Existing Accelerator Driven Subcritical Systems (ADS)

There are major drawbacks in the approach of using the current versions of ADS. The minor actinides for feeding in an ADS are extracted from spent fuels and processed to suite for the ADS design. There are required intermediate processes for the purpose of separating plutonium, uranium, and minor actinides and then combine these nuclides to make new fuels suitable for the ADS. The involved intermediate processes would create additional radioactive wastes with added cost. Such undesirable conditions share the same difficulties with the reprocessing tasks of making the advanced fuels for power production such as the MOX fuels for light water reactors or for fast reactors.

There are difficulties arising from the additional nuclear wastes generated during fuel recycling. Although these additional nuclear wastes are not of high-level radioactivity, they are still costly to handle and clean up. The cleanup cost is a huge and increasing number that the recycling hosts must face and have faced unexpectedly during the past years. (23) These factors apparently are viewed as an obstacle for continuing extracting plutonium off the spent fuels. The same considerations are applicable to the processing tasks required for operating an ADS to eliminate high level wastes.

Unique Nature of this Invention

In order to eliminate the intermediate processes of extracting plutonium and minor actinide from spent fuels, the spent fuels from light water reactors could be fed directly into an ADS with the new features disclosed in this invention. This invention adopts a notion that the spent fuels from light water reactor are used directly in their intact form in an ADS. To accommodate the full length of spent fuels from a light water reactor, more than one accelerator ports would likely be required for an ADS. The purpose for adopting more than one accelerator intake port is to cover the entire spent fuel length with the distribution of neutrons produced with the incoming protons to sustain enough nuclear reactions everywhere in the core under subcritical conditions.

The ADS core with the new features disclosed consists of assemblies of spent fuels, primary coolant channels, and possibly special channels for plutonium or uranium fuel elements. The primary coolant is flowing in the space external to the spent fuel channels and to the parallel channels with plutonium and uranium. Additional plutonium fuels could be placed in parallel with the LWR spent fuels when deemed warranted. The heat generated from nuclear reactions under subcritical conditions will be transported by the coolant and sent to a heat exchanger or heat exchangers outside the ADS core. Water would be considered as a secondary coolant in the heat exchanger and after being heated will produce steam to drive a turbine for generating electricity.

Technical Description

This invention changes the costly and cumbersome two-stratum fuel cycle approach by combining the two-stratum into one in the overall strategy of addressing the issues related to spent fuels and nuclear waste. The novelty of this invention involves the use of multiple proton intake ports with extended dimensions for the core and multiple targets or multiple locations in one target for proton spallation. The purpose of extending the dimension from an existing design of an ADS is to accommodate the full length of spent fuels from light water reactors. The new design concept is to feed the LWR spent fuels directly into an ADS, with the disclosed features. To furnish enough neutrons to the subcritical core of extended length, multiple proton intake ports with proton flow modulation external to the reactor vessel are designed as another new feature of this invention.

### BRIEF SUMMARY OF THE INVENTION

### Technical Problem

This invention can address directly several key problematic issues in the processes of fuel cycle and the elimination of the ultimate nuclear wastes. The following is a list of such issues.

1.

During the implementation of recycling the spent fuels by extracting fissile materials and remaking the fuels using the extracted fissile materials, additional radioactive materials are generated.

2.

The extracted fissile materials from spent fuels have been one of the main concerns for proliferation as these materials contain fissile isotopes of plutonium and uranium, which are the materials for weapon.

3.

Manufacturing the fuels to specifically suite for an accelerator driven subcritical reactor bears technical complexities and additional costs.

4.

Spent fuels from light water reactors worldwide are stored on site in temporary water pools or dry casks. It is estimated that it would take another 10 to 20 years before the congested situation could be alleviated by either sending the spent fuels out of nuclear plant sites for recycling or storing in a repository.

### Solution to Problem

The features of the newly designed ADS presented by this invention intends to solve all these problems altogether. The adoption of multiple accelerator proton intake ports can accommodate the full length spent fuels with the multiple neutron sources in the reactor core. The multiple proton intake ports will allow the arrangement of multiple neutron sources in the core by placing the spallation targets at desirable locations axially, or by designing a target of more than one spallation locations. The multiple neutron sources would enhance the strength of neutrons by its ability to achieve the desirable levels of transmutation and fission reactions. Such arrangement can also accommodate the variation in the distributions for plutonium, uranium and minor actinides in the spent fuels. The capability of external modulation on the strength of the neutron sources and neutron flux distributions can achieve the desirable neutronic environments that would not otherwise be accomplished by the prefabricated fuels of fixed ratios of plutonium and minor actinides.

### Advantageous Effect of the Invention

1.

Feeding the spent fuels from light water reactors directly into the ADS, the intermediate steps that would generate the additional radioactive materials is eliminated.

2

Skipping the extraction step of processing would address the proliferation concern by a large scale.

3.

Direct adopting spent fuels from light water reactor for use in an ADS would be a cost saving endeavor as this approach would eliminate the steps of generating additional radioactive materials and the steps of making new fuels of extracted fissile materials.

4.

The storage problem for the spent fuels will be eased as most of the spent fuels could be shipped to an ADS directly for the elimination of the nuclear wastes and for the consumption of leftover fissile materials to produce power.

5.

Using multiple proton ports in an Accelerator Driven Subcritical reactor to create multiple neutron sources in various core locations axially will enhance the effectiveness of the fission rates for transmutation and energy production for the full length of spent fuels from light water reactors.

6.

The proton fluxes from different ports could be modulated externally to create different neutron sources at various axial locations. Such external arrangement could effectively modulate the neutron fluxes for different locations to accommodate the positional variation in the spent fuels of different ratios of minor actinides and major actinides.

7.

This is a new concept. The current approach for ADSs is to prefabricate the fuels with a predetermined ratio of plutonium and minor actinides. This a costly endeavor when the fuel elements need to be shuffled or replaced. The multiple proton ports approach proposed by this invention could effectively replace the existing approach and thereby revolutionize the concept for the ADS fuels. The multiple proton port approach to create multiple neutron sources would take full advantage of the subcritical nature of the reactor core by fully relying on the neutron supply driven from external sources. As the neutrons are mainly driven externally for subcritical reactors, the control of the neutron source strength can also be modulated externally by delivering protons via streams of different fluxes and energies. This adds an additional flexibility for controlling the neutron spectrum in the reactor core. Such ability of controlling the neutron distribution in a core by external modulating could add significant maneuverability for managing the fuel elements to arrange the core for a required configuration. It would also add the ability to accommodate the various ratios of Plutonium and minor actinides in spent fuels.

### DETAILED DESCRIPTION OF THE INVENTION

### Brief Description of the Drawings

FIG. 1 shows Embodiment 1 for an accelerator driven subcritical core with an arrangement for three sideway proton intake ports in vertical cross sectional view. The core layout includes a target of three spallation locations, fuel rods, the reflector, and the shielding.

FIG. 2 shows a schematic view of Embodiment 1 for the accelerator driven subcritical core with three sideway proton intake ports. The three spallation locations in the target to receive protons delivered through the sideway intake ports are shown.

FIG. 3 shows a schematic for Embodiment 1 for the accelerator driven subcritical core with an external view of the three sideway proton intake ports connected to reactor vessel.

FIG. 4 shows a vertical cross-sectional view of Embodiment 2 for half of this newly featured accelerator driven subcritical core with the target arrangement for the two way (top and bottom) proton intake ports with the core vertical centerline as the left boundary of the sketch. The target area, fuel elements, reflectors and shielding are shown in this figure.

FIG. 5 shows a vertical cross-sectional view of Embodiment 2 for the accelerator driven subcritical core with fuels, the proton intake ports from top and bottom of the core, and the target to receive protons with two spallation locations in the target.

FIG. 6 shows a 3D view of Embodiment 2 for the accelerator driven subcritical core with two proton intake ports delivering protons to the ADS core.

FIG. 7 shows a schematic view of Embodiment 2 for the accelerator driven subcritical core with the two way (top and bottom) proton intake ports delivering protons for bombarding a target at two ends in the ADS Core. FIG. 7 also shows Embodiment 7 of the external proton flux modulation units with a control device for these units.

FIG. 8 shows a schematic view of Embodiment 3 for the accelerator driven subcritical reactor with a proton intake port delivering protons in two parallel streams to the ADS core from top of the vessel with the target to receive the incoming protons at two spallation locations in the target. Such target arrangement is named as Step Down arrangement. FIG. 8 also shows Embodiment 7 of the external proton flux modulation unit on top of the vessel unit for modulating the two proton streams.

FIG. 9 shows a schematic view of Embodiment 4 for the accelerator driven subcritical reactor with a proton intake port delivering protons in two parallel streams to the ADS core from bottom of the vessel with the target to receive the incoming protons at two spallation locations in the target. Such target arrangement is named as Step Up arrangement.

FIG. 10 shows a schematic view of Embodiment 5 for the accelerator driven subcritical reactor with a port delivering protons in three parallel streams to the ADS core from top of the vessel with a target to receive the incoming protons at three spallation locations in the target. FIG. 10 also shows Embodiment 7 of the external proton flux modulation unit for modulating the three proton streams from top of the vessel.

FIG. 11 shows a schematic view of Embodiment 6 for the accelerator driven subcritical reactor with a port delivering protons in three parallel streams to the ADS core from bottom of the vessel with the target to receive the incoming protons at three spallation locations in the target.

FIG. 12 Shows Embodiment 7 for the accelerator driven subcritical core with three sideway proton intake ports with an external proton flux modulation unit to accommodate a three-way split from a single accelerator and a control device to manage and adjust the neutrons fluxes diverted into the three intake ports.

### DETAILED DESCRIPTION OF THE PREFERRED EMBODIMENTS

Working Principles

All the existing ADS designs adopt only one proton port to deliver protons from an external accelerator into the reactor core of ADS. The protons collide with a target placed in the center of the core and generate neurons that will scatter into the ADS core. The neutrons will interact with the fuels made of plutonium isotopes and minor actinides taken from the spent fuels from light water reactors by recycling. The nuclear reactions by these generated neutrons would eliminate minor actinides and produce power at the same time.

The working principle for this invention is to use more than one proton ports that deliver protons to an ADS with the disclosed features from top, or bottom or both, of the reactor vessel, or from sideways of the reactor vessel. Each of the multiple proton ports, could deliver protons generated from multiple accelerators with the arrangement that one intake port is connected to one accelerator. Or, all the protons delivered through the multiple ports are generated by only one single accelerator with a modulation unit connecting all the ports serving as flow splitter for the protons diverted into the various ports.

Each proton port will deliver protons into the ADS core to collide with a spallation target inside the core and generate neutrons that scatter into the bulk volume of the core. The multiple ports arrangement would accomplish several purposes:

1.

It could furnish ample neutrons in a subcritical core to accommodate the full length of spent fuels from light water reactors.

2.

Such arrangement could modulate the neutron flux distribution to accommodate the variation in the distribution of plutonium and minor actinides delivered directly in the spent fuels.

3.

Such arrangement could add flexibility to modulate for the desired internal power distribution by changing externally the ratio of proton fluxes diverted into different ports, for safety, engineering, and other considerations.

4.

The external modulation unites could also modulate the energies delivered by the various proton streams into the reactor. This adds more flexibility in controlling the neutron spectrum in the reactor core.

5.

The longitudinal target placed in the axial center of the core is signed to have different geometries such that the delivered proton streams will arrive at the different axial locations in the target. This arrangement will create more than one axial locations in the target for proton spallation reactions on the target, effectively creating multiple neutron sources to accommodate the full length of the spent fuels taken directly from light water reactors.

### Embodiment 1

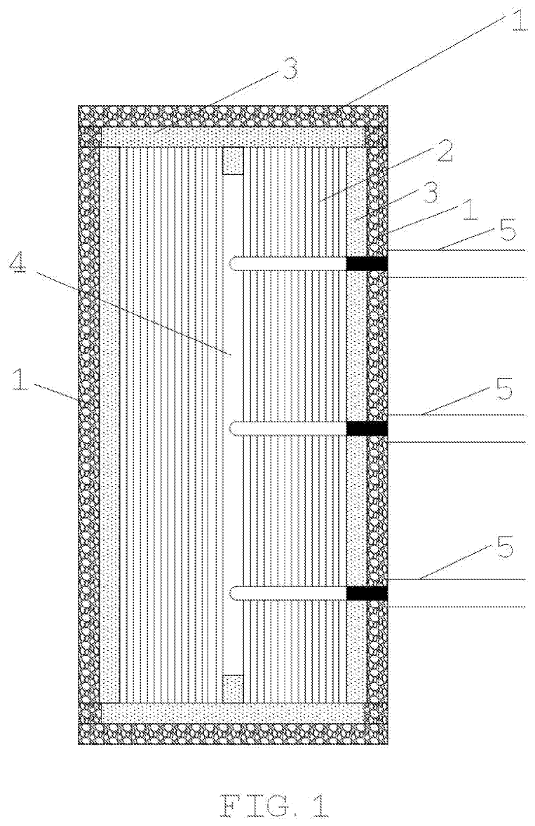

Three sideway proton intake ports 5 are connected to an accelerator driven subcritical reactor and deliver protons into the core to collide with the target 4 placed in the center of the ADS reactor core. The vertical cross section side view for this arrangement is presented in FIG. 1. In this figure, it shows the ADS core includes spent fuels 2 taken from light water reactors, and an external layer of reflector materials 3. Another layer outward along the radial direction is the shielding material 1.

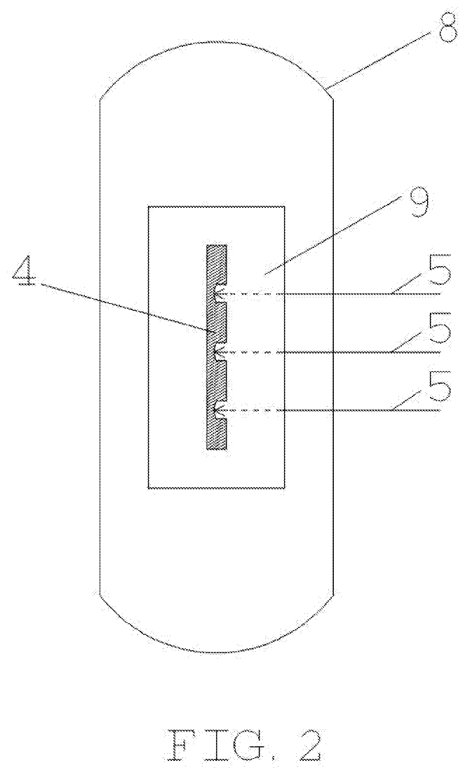

FIG. 2 shows the reactor vessel 8 of the accelerator driven subcritical core 9 with three sideway proton intake ports, each port 5 delivers protons from one or more accelerators. The protons are delivered to the ADS core 9 to collide with the spallation targets 4 for producing neutrons.

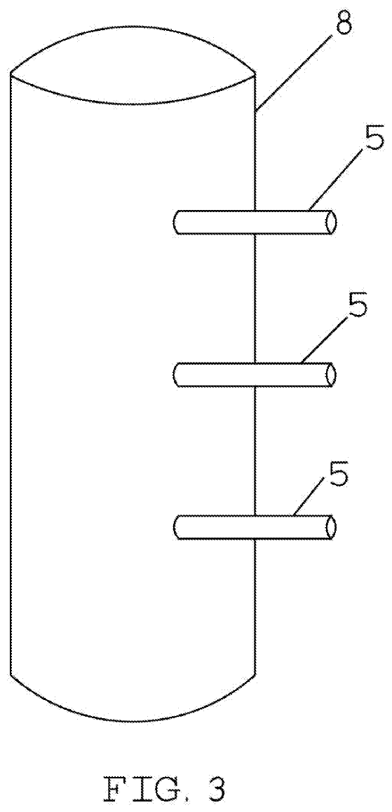

FIG. 3 shows that the three sideway proton intake ports 5 are connected to and penetrate through the reactor vessel wall 8.

### Embodiment 2

Embodiment 2 is a design of a target of two spallation locations for receiving two protons streams, one from the top of the reactor and the other from the bottom of the reactor.

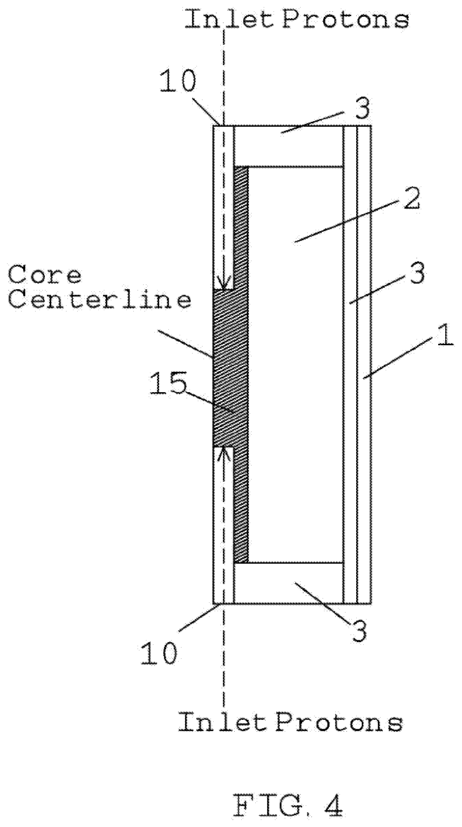

FIG. 4 shows the vertical cross-sectional view for half of the ADS core. Two proton intake ports 10 are connected to the ADS core, one port 10 delivers protons from top of the reactor, and the other from bottom of the core. The spallation target 15, the fuels 2, reflector 3, and the shielding 1 are shown in the figure.

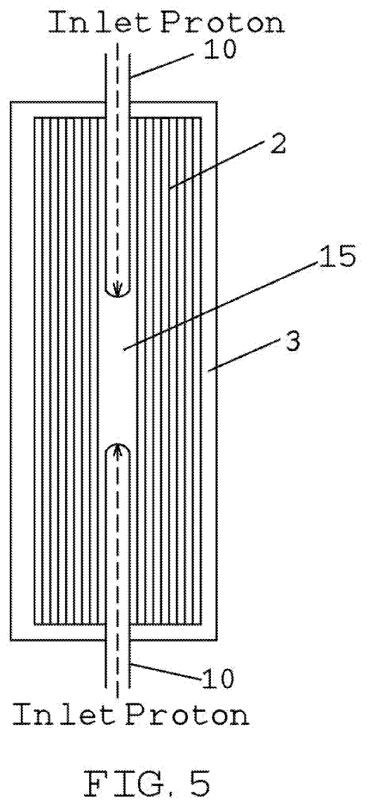

FIG. 5 shows the vertical cross-sectional view for the ADS core with fuel elements and two proton intake ports 10. One proton port enters the reactor from the top of the core and the other enters from the bottom of the core.

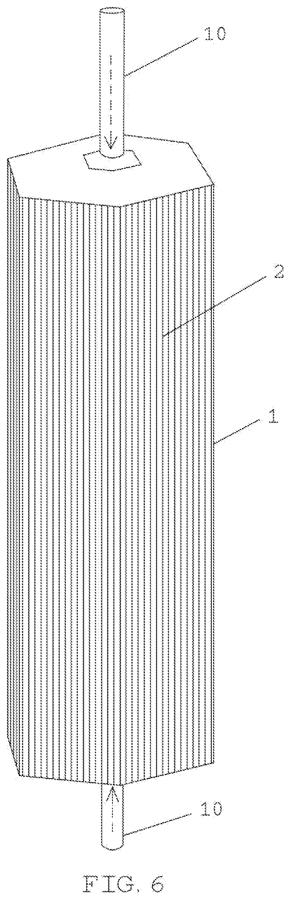

FIG. 6 shows a 3D view of the ADS core, with fuel elements 2 and two two-way proton intake ports 10.

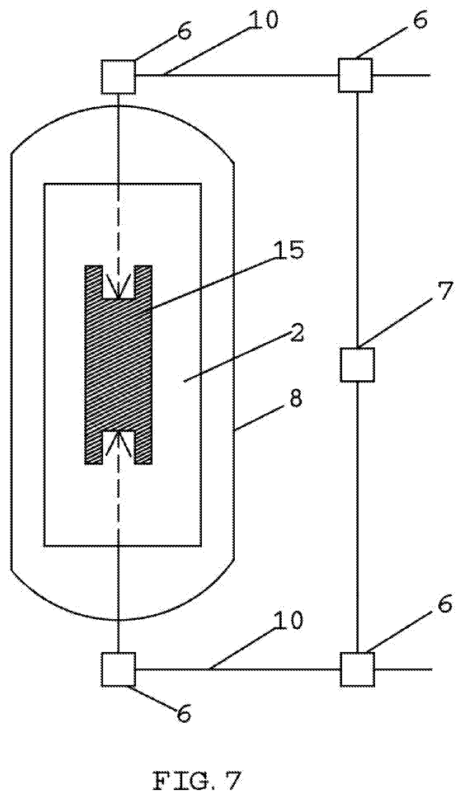

FIG. 7 shows a reactor vessel that houses the ADS core with two proton intake ports connected to the core, one from top, and the other from bottom of the core. The target of two spallation locations are shown.

### Embodiment 3

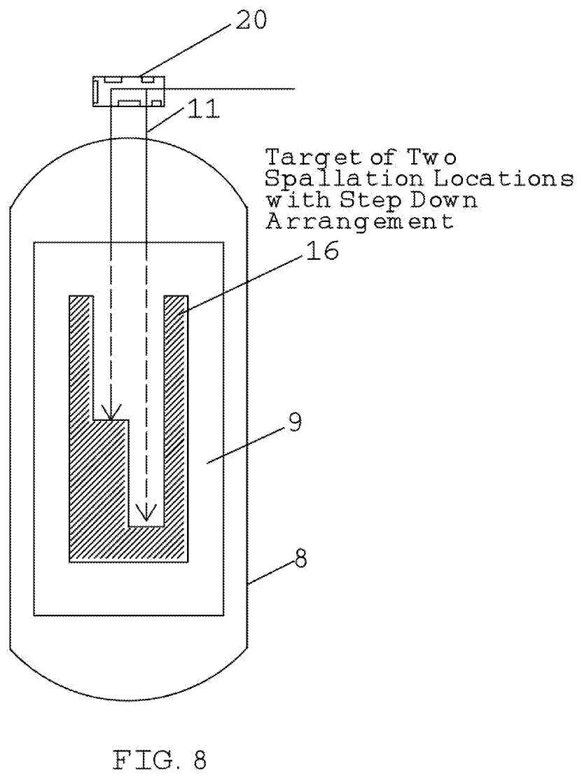

FIG. 8 shows one proton intake port, entering the core from top of the vessel for delivering protons to the core. The target is specifically designed to have a Step Down shape to accommodate two proton streams for colliding with the target at two different axial locations along the center axis of the core such that there will be two neutron sources located strategically for maximizing the effectiveness of nuclear reactions.

A modulation unit in the intake port on top of the vessel could deliver protons for the two proton streams at different energies and fluxes. This arrangement could make the neutrons generated at the two target locations with different energies and quantities. The modulation unit 20 on top of the vessel that would have magnet arrangements inside to perform the functions of bending the proton flow direction from horizontal to downward as well as splitting the proton flows to two proton steams of different energies and fluxes.

### Embodiment 4

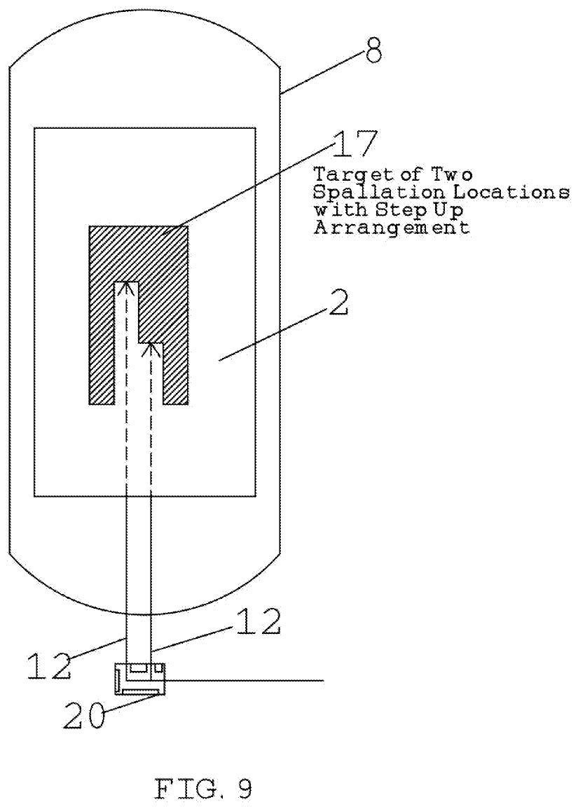

FIG. 9 shows one proton intake port, entering the core from bottom of the vessel for delivering protons to the core. The target is specifically designed to have a Step Up shape to accommodate two proton streams for colliding with the target at two different axial locations along the center axis of the core such that there will be two neutron sources located strategically for maximizing the effectiveness of nuclear reactions.

A modulation unit in the intake port on top of the vessel could deliver protons for the two proton streams at different energies and fluxes. This arrangement could make the neutrons generated at the two target locations with different energies and quantities.

This Embodiment is a mirror image of Embodiment 3.

### Embodiment 5

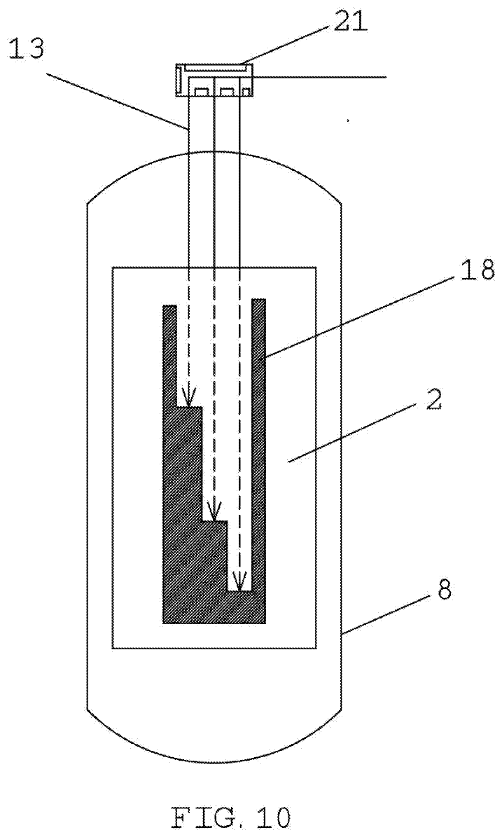

FIG. 10 shows one proton intake port, entering the core from top of the vessel for delivering protons to the core. The target is specifically designed to have a Step Down shape to accommodate three proton streams for colliding with the target at three different axial locations along the center axis of the core such that there will be three neutron sources located strategically for maximizing the effectiveness of nuclear reactions.

A modulation unit in the intake port on top of the vessel could deliver protons for the three proton streams at different energies and fluxes. This arrangement could make the neutrons generated at the three target locations with different energies and quantities. The modulation unit 21 on top of the vessel that would have magnet arrangements inside to perform the functions of bending the proton flow direction from horizontal to downward as well as splitting the proton flows to three proton steams of different energies and fluxes.

### Embodiment 6

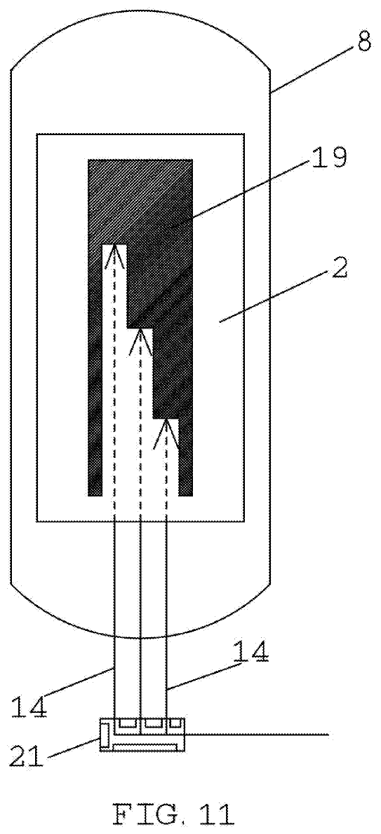

FIG. 11 shows one proton intake port, entering the core from bottom of the vessel for delivering protons to the core. The target is specifically designed to have a Step Up shape to accommodate three proton streams for colliding with the target at three different axial locations along the center axis of the core such that there will be three neutron sources located strategically for maximizing the effectiveness of nuclear reactions.

A modulation unit in the intake port on top of the vessel could deliver protons for the three proton streams at different energies and fluxes. This arrangement could make the neutrons generated at the three target locations with different energies and quantities. The modulation unit 21 on top of the vessel that would have magnet arrangements inside to perform the functions of bending the proton flow direction from horizontal to downward as well as splitting the proton flows to three proton steams of different energies and fluxes.

This Embodiment is a mirror image of Embodiment 5.

### Embodiment 7

The proton influx flows delivered through the proton intake ports could be modulated by external modulation units as a flow splitter. This arrangement could control the proton flows at the various target locations inside the core such that the generated neutrons from target spallation by protons could be modulated accordingly. This is a unique feature for the modulation unit by which the internal neutron source strength at different spallation locations can be modulated externally. Therefore, the neutron fluxes and the reactor power distribution could be modulated through an external control. The desired power distribution and burnup distribution for minor actinides in the core could be controlled by such arrangements, without the tedious effort of redesigning the fuel elements for accomplishing the same.

FIG. 7 shows the external modulation arrangement for a two port intake proton ports. The protons delivered through a port could be modulated for their flow quantity and energy by a Modulation Unit 6. The Modulation Units 6 could be controlled by a Central Control Device 7 for adjusting the splitting ratio between the ports.

FIG. 8, FIG. 9, FIG. 10, and FIG. 11 all show the modulation units for proton incoming streams either from top or the bottom of the vessel. These figures also show the modulation units for splitting the incoming protons into two streams or three streams.

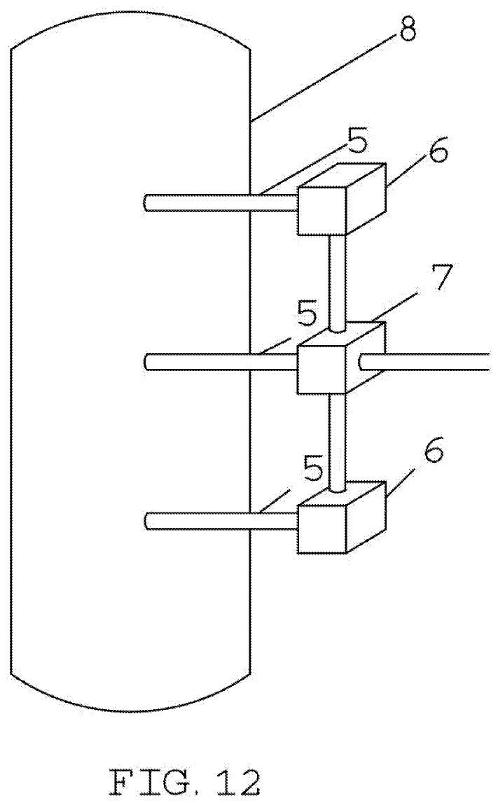

FIG. 12 shows the external modulation arrangement for a sideway three port intake proton ports. The Central Control Device 7 in this figure shows that it could perform the proton flow splitting from a single accelerator, while FIG. 7 shows the controlling functions for multiple accelerators.

### LIST OF REFERENCE CAPTION NUMBERS IN FIGURES

1. Shielding
2. Fuel
3. Reflector
4. Spallation Target of Three Proton Spallation Locations
5. Sideway Proton Intake Port
6. Proton Flux Modulator
7. Proton Flux Modulator Control Device
8. Reactor Vessel
9. Accelerator Driven Subcritical (ADS) Core
10. Axial Proton Intake Port
11. Top Proton Port of One Way Two Path Neutron Streams
12. Bottom Proton Port of One Way Two Path Neutron Streams
13. Top Proton Port of One Way Three Path Neutron Streams
14. Bottom Proton Port of One Way Three Path Neutron Streams
15. Target of Two Axial Spallation Locations for Top and Bottom Proton Ports with Concave Arrangement at Two Ends
16. Target of Two Axial Spallation Locations for Top Proton Port of One Way Two Path Neutron Streams with Step Down Arrangement
17. Target of Two Axial Spallation Locations for Bottom Proton Port of One Way Two Path Neutron Streams with Step Up Arrangement
18. Target of Three Axial Spallation Locations for Top Proton Port of One Way Three Path Neutron Streams with Step Down Arrangement
19. Target of Three Axial Spallation Locations for Bottom Proton Port of One Way Three Path Neutron streams with Step Up Arrangement
20. Modulation Unit for Control of Proton Fluxes in Two Parallel Paths
21. Modulation Unit for Control of Proton Fluxes in Three Parallel Paths

### REFERENCES

1.
Zijia Zhao a, Zhong Chen, Hongli Chen, “Preliminary optimization of proton energy and target for Lead-Bismuth Eutectic target of a demonstration ADS,” Progress in Nuclear Energy, Vol. 71, (2014), pp. 117-121.
2.
Zhong Chen, Yican Wu, Baoxin Yuan, Dongmei Pan, “Nuclear waste transmutation performance assessment of an accelerator driven subcritical reactor for waste transmutation (ADS-NWT),” Annals of Nuclear Energy, Vol. 75, (2015), pp. 723-727.
3.
Xunzhao Li, Shengcheng Zhou, Youqi Zheng, Kunpeng Wang, Hongchun Wu, “Preliminary studies of a new accelerator-driven minor actinide burner in industrial scale,” Nuclear Engineering and Design, Vol. 292, (2015), pp 57-68.
4.
Xuesong Yan, Lei Yang, Xunchao Zhang, and Wenlong Zhan, “Concept of an Accelerator-Driven Advanced Nuclear Energy System,” Energies, 10, 2017, pp. 944.
5.
Wenlong Zhan, “Recent ADS/DANES Activities in China EuCARD/CERN,” Chinese Academy of Science, Feb. 7, 2017.
6.
Chinese lead-bismuth test reactor starts up, World Nuclear News, Vol. 16, October 2019.
7.
Hamid Aït Abderrahim, Peter Baeten, Didier De Bruyn, Rafael Fernandez, MYRRHA—“A multi-purpose fast spectrum research reactor,” Energy Conversion and Management, Vol. 63, (2012).
8.
Alex C. Mueller, “Transmutation of Nuclear Waste and the future MYRRHA Demonstrator,” J. Phys. Conf. Ser. (2013), 420 012059.
9.
Didier De Bruyn, Hamid Aït Abderrahim, Peter Baeten, Paul Leysen, “The MYRRHA ADS Project in Belgium Enters the Front End Engineering Phase,” Physics Procedia, Vol. 66, (2015), pp. 75-84.
10.
Toni Feder, “Belgium Presses on with Accelerator-Driven Research Reactor,” Physics Today, December 2018, pp. 31.
11.
Tsujimoto, K., Sasa, T., Nishihara, K., Oigawa, H., Takano, H., “Neutronics design for lead-bismuth cooled accelerator-driven system for transmutation of minor actinide,” Journal of Nuclear Science and Technology, 41, (2004), pp. 21-36.
12.
Kazufumi Tsujimoto, “Research and development activities for accelerator-driven system in JAEA,” Progress in Nuclear Energy, 106, (2018), pp. 27-33.
15.
Takanori Sugawara, Yuta Eguchi, Hironari Obayashi, Hiroki Iwamoto, Kazufumi Tsujimoto, “Conceptual design study of beam window for accelerator-driven system with subcriticality adjustment rod,” Nuclear Engineering and Design, 331, (2018), pp. 11-23.
16.
Takanori Sugawara, Ryota Katano, and Kazufumi Tsujimoto, “Impact of impurity in transmutation cycle on neutronics design of Toshinobu Sasa, “Research Activities for Accelerator-Driven Transmutation System at JAERI, Progress in Nuclear Energy,” Vol. 47, No. 1-4, (2005), pp. 314-326.,
13.
Kazufumi Tsujimoto, Toshinobu Sasa, Kenji Nishihara, Hiroyuki Oigawa & Hideki Takano, “Neutronics Design for Lead-Bismuth Cooled Accelerator-Driven System for Transmutation of Minor Actinide,” Journal of Nuclear Science and Technology, 41-1 (2012), pp. 21-36.
14.
Takanori Sugawara, Hayanori Takei, Hiroki Iwamoto, Akito Oizumi, Kenji Nishihara, revised accelerator-driven system,” Annals of Nuclear Energy, Volume 111, (January 2018), pp. 449-459.
17.
S. F. Sidorkin, L. V. Kravchuk, A. V. Feschenko, “The Troitsk ADS project,” Institute for Nuclear Research Russian Academy of Sciences, 60th October Anniversary Prospect 7a, Moscow 117312, Russia, M. Bourquin, F. Carminati, J.-C. de Mestral, F. Gerigk, V. Grichine, R. Gimalov, Y. Kadi, E. Lillestol, M. Losasso, J.-P. Revol, K. Samec, International Thorium Energy Committee, 17, rue Francois-Dussaud, 1217 Geneva, Switzerland, CERN, 9 Feb. 2017.
18.
P. Singh, “Indian ADS Programme,” Workshop on Status of Accelerator Driven Systems Research and Technology Development, CERN, Feb. 7-9, 2017
19.
Allan G. Pulsipher, “A de facto Repository for the USA: “The Risk of Interim Storage of High-Level Nuclear Waste,” Energy Policy, Volume 21, Issue 7, July 1993, Pages 798-812.
20.
Luisa Kenausis, “Nuclear Waste Issues in the United States,” Center for Arms Control and Non-Proliferation, Aug. 22, 2018.
21.
Jeff McMahon, “New Map Shows Expanse of U.S. Nuclear Waste Sites,” Forbes, May 31, 2019.
22.
“Disposal of High-Level Nuclear Waste,” U.S. GAO Key Issues, Mar. 29, 2020.
23.
Mycle Schneider and Yves Marignac, “Spent Nuclear Fuel Reprocessing in France, International Panel on Fissile Materials,” April 2008.
24.
“The Future of the Nuclear Fuel Cycle, an MIT Interdisciplinary Study,” 2011, MIT.
25.
P. Souc̆ek, R. Malmbeck, “Pyrochemical processes for recovery of actinides from spent nuclear fuels,” Woodhead Publishing Series in Energy, (2015), pp. 437-456
26.
K. Minato, “Development of closed nuclear fuel cycles in Japan,” Woodhead Publishing Series in Energy, (2015), pp. 565-578.
27.
Rubbia C. et al. “Conceptual design of a fast neutron operated high power Energy Amplifier,” Technical Report CERN/AT/95-44(ET), CERN (1995).
28.
Gandini, A. and Salvatores, M. “The physics of subcritical multiplying systems,” Journal of Nuclear Science and Technology, 39, (2002), 673-686.
29.
Magill, J., Berthou, V., Haas, D., Galy, J., Schenkel, R., Wiese, H. W., Youinou, G. “Impact limits of partitioning and transmutation scenarios on the radiotoxicity of actinides in radioactive waste,” Nuclear Energy, 42(5), (2003), 263-277.
30.
Meiliza, Y., Saito, M., Sagara, H. “Protected Plutonium Breeding by Transmutation of Minor Actinides in Fast Breeder Reactor,” Journal of Nuclear Science and Technology, (2008).
31.
Fairhall, G., “Minor Actinide Transmutation Position Paper,” U.K. National Nuclear Laboratory, (2011).
32.
Salvatores, M., Palmiotti, G., “Radioactive waste partitioning and transmutation within advanced fuel cycles: Achievements and challenges,” Progress in Particle and Nuclear Physics, Vol. 66, (2011), pp. 144-166.
33.
Yang, C., Cao, L. Z., Wu, H. C., Zheng, Y. Q., & Zu, T. J., “Minor actinide transmutation analysis of fusion-driven subcritical system,” Yuanzineng Kexue Jishu/Atomic Energy Science and Technology, (2013).
34.
Kazansky, Y. A., Romanov, M. I., “Transmuting minor actinides with thermal reactor neutrons,” Nuclear Energy and Technology, (2016).
35.
R. Plukienéa, A. Plukisa, L. Juodisa, V. Remeikisa, O. S̆alkauskasa, D. Ridikasb, W. Gudowskic, “Transmutation considerations of LWR and RBMK spent nuclear fuel by the fusion-fission hybrid system” Nuclear Engineering and Design, 330, (2018), 241-249.

1. An arrangement of proton intake ports for delivering protons into a nuclear subcritical core with three sideway parallel proton intake ports penetrating through the reactor vessel, delivering protons externally from one or more accelerators into reactor core with proper dimensions and internal designs for accommodating the full length spent fuels taken directly from light water reactors, for transmutation of minor actinides in spent fuels while producing power in them by fission reactions under subcritical modes.

2. A center piece of bombardment target or targets according claim 1, with an arrangement of three bombardment locations in said target, axially aligned with the core axis to receive protons from said intake ports for colliding with said target or targets to cause spallation reactions for the purpose of producing neutrons that interact with the fissile materials and minor actinides in the full length spent fuels.

3. According to claim 1, one or more modulation units in said external proton intake ports to control and modulate the incoming proton streams to have different fluxes and energies in each of said proton intake ports.

4. An arrangement of two axial intake ports that delivers protons externally from one or more accelerators, such that one port enters from top of the reactor vessel and the other enters from the bottom of the vessel.

5. According to claim 4, a longitudinal target unit in the center of the core arranged axially, to receive protons from said two proton intake ports, with a concave arrangement at the two ends of said target, to receive protons from said two proton intake ports, one from top and the other from bottom of the reactor core, for receiving protons from said intake ports to collide with the target material or materials via spallation for the purpose of producing neutrons at two locations in said target.

6. According to claim 4, one or more modulation units in said external proton intake ports to control and modulate the incoming proton streams to have different fluxes and energies in each of said proton intake ports.

7. An axial intake port that delivers protons externally from an accelerator or accelerators, a center piece of longitudinal bombardment target with an arrangement of two receiving locations in said target to receive protons for the spallation reactions with said target at two axial positions to produce neutrons as two neutron sources. Said proton intake port entering the reactor vessel from top of the vessel, with incoming proton streams arriving the core at said two axial locations with a step-down arrangement for said target, such that spallation reactions in said target will occur at said two axial locations in said target.

8. An axial intake port that delivers protons externally from an accelerator or accelerators, a center piece of longitudinal bombardment target with an arrangement of two receiving locations in said target to receive protons for the spallation reactions with said target at two axial positions to produce neutrons as two neutron sources. Said proton intake port entering the reactor vessel from bottom of the vessel, with incoming proton streams arriving the core at said two axial locations with a step-up arrangement for said target, such that spallation reactions in said target will occur at said two axial locations in said target.

9. According to claim 7 and claim 8, a proton influx modulator in said intake port to make the protons delivered through the intake port split into two proton streams via a design of magnet and collimator arrangements in said modulator, such protons of each stream arriving at a different axial location in said target, such that each stream be adjusted by said modulator according to the desired fluxes and energies.

10. An axial intake port that delivers protons externally from an accelerator or accelerators, a center piece of longitudinal bombardment target with an arrangement of three receiving locations in said target to receive protons for the spallation reactions with said target at three axial positions to produce neutrons as three neutron sources. Said proton intake port entering the reactor vessel from top of the vessel, with incoming proton streams arriving the core at said three axial locations with a step-down arrangement for said target, such that spallation reactions in said target will occur at said three axial locations in said target.

11. An axial intake port that delivers protons externally from an accelerator or accelerators, a center piece of longitudinal bombardment target with an arrangement of three receiving locations in said target to receive protons for the spallation reactions with said target at three axial positions to produce neutrons as three neutron sources. Said proton intake port entering the reactor vessel from bottom of the vessel, with incoming proton streams arriving the core at said three axial locations with a step-up arrangement for said target, such that spallation reactions in said target will occur at said three axial locations in said target.

12. According to claim 10 and claim 11, a proton influx modulator or modulators in said intake port to make the protons delivered through the intake port split into three proton streams via a design of magnet and collimator arrangements in said modulator or modulators, each stream of protons arriving at a different said location in said target, such that the fluxes and the energies of said streams be adjusted by said modulator or modulators according to the desired values.

13. An axial intake port that delivers protons externally from an accelerator or accelerators, a center piece of longitudinal bombardment target with an arrangement of more than three locations in said target to receive protons for the spallation reactions with said target at said axial positions to produce neutrons as more than three neutron sources. Said proton intake port connects the reactor vessel from top of the vessel, with incoming proton streams arriving the core at said locations with a step-down arrangement for said target such that spallation reactions in said target will occur at said locations in said target.

14. An axial intake port that delivers protons externally from an accelerator or accelerators, a center piece of longitudinal bombardment target with an arrangement of more than three locations in said target to receive protons for the spallation reactions with said target at said axial positions to produce neutrons as more than three neutron sources. Said proton intake port connects the reactor vessel from bottom of the vessel, with incoming proton streams arriving the core at said locations with a step-up arrangement for said target such that spallation reactions in said target will occur at said locations in aid target.

15. According to claim 13 and claim 14, a proton influx modulator or modulators in said intake port to make the protons delivered through said intake port split into more than three proton streams via a design of magnets and collimator arrangements for said modulator or modulators, each stream of protons arriving at a different said locations in said target, such that the fluxes and the energies of each neutron stream be adjusted by said modulator or modulators according to the desired values.
